(19) United States
(12) Patent Application Publication
(10) Pub. No.: US 2004/0089637 A1
(43) Pub. Date: May 13, 2004

(54) Method for cutting a photoresist-coated glass board, cutting machine for cutting a photoresist-coated glass board and method for manufacturing an optical recording medium

(75) Inventors: Syuji Tsukamoto, Chuo-ku (JP); Hiroyuki Arioka, Chuo-ku (JP); Yuuichi Kawaguchi, Chuo-ku (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Chuo-ku (JP)

(21) Appl. No.: 10/691,851

(22) Filed: Oct. 23, 2003

(30) Foreign Application Priority Data
Oct. 25, 2002 (JP) 2002-310989

(51) Int. Cl. B23K 26/00

(52) U.S. Cl. 219/121.6

(57) ABSTRACT

The present invention relates to a method for cutting a photoresist-coated glass board used for fabricating a stamper for an optical recording medium and the method includes steps of intermittently projecting a first laser beam onto the photoresist-coated glass board and intermittently projecting a second laser beam in synchronism with blocking the first laser beam onto the photoresist-coated glass board, thereby continuously and spirally forming an exposed region. According to the present invention, it is possible to obtain a high aperture ratio and suppress fluctuation of a local groove parameter at a land pre-pit portion.

### BACKGROUND OF THE INVENTION

The present invention relates to a method and a cutting machine for cutting a photoresist-coated glass board and, particularly, to a method for cutting a photoresist-coated glass board which can obtain a high aperture ratio and suppress fluctuation of a local groove parameter at a land pre-pit portion and a cutting machine for cutting a photoresist-coated glass board which can obtain a high aperture ratio and suppress fluctuation of a local groove parameter at a land pre-pit portion.

Further, the present invention relates to a method for manufacturing an optical recording medium and, particularly, to a method for manufacturing an optical recording medium which has a high aperture ratio and in which requirements for various parameters such as jitter, PI errors (Paruty of inner-code errors), detracking tolerance and the like can be simultaneously satisfied in a desired manner.

### DESCRIPTION OF THE PRIOR ART

Optical recording media such as the CD, DVD and the like have been widely used as recording media for recording digital data. These optical recording media can be roughly classified into optical recording media such as the CD-ROM and the DVD-ROM that do not enable writing and rewriting of data (ROM type optical recording media), optical recording media such as the CD-R and DVD-R that enable writing but not rewriting of data (write-once type optical recording media), and optical recording media such as the CD-RW and DVD-RW that enable rewriting of data (data rewritable type optical recording media).

In a ROM type optical recording medium, data are held in the form of a pit row formed on a substrate in the manufacturing process thereof. The pit row is spirally formed on the substrate and data held in the optical recording medium can be reproduced by projecting a laser beam onto the optical recording medium along the pit row and detecting the amount of the laser beam reflected from the optical recording medium.

To the contrary, in a write-once optical recording medium or a data rewritable type optical recording medium, a recording layer containing an organic dye or a phase-change material is formed on a substrate and data are recorded in the optical recording medium by projecting a laser beam whose intensity is being modulated onto the recording layer along a groove spirally formed on the substrate in the manufacturing process thereof and chemically changing the organic dye or the phase-change material or chemically changing the organic dye or the phase-change material and physically deforming the recording layer, thereby forming a record mark. On the other hand, data recorded in the optical recording medium are reproduced by projecting a laser beam onto the recording layer along the groove spirally formed on the substrate and detecting the amount of the laser beam reflected from the recording layer.

The groove formed on the substrate of a write-once optical recording medium or a data rewritable type optical recording medium wobbles in the radial direction of the optical recording medium at a predetermined cycle. Therefore, when data are to be recorded, it is possible to maintain the linear recording velocity constant irrespective of the position in the radial direction of the optical recording medium by generating a synchronization signal for the rotation servo of the spindle motor based on the detected wobble signal (WO signal).#

Further, a number of pits called “land pre-pits” are formed in a land region between neighboring grooves in the manufacturing process and when data are to be recorded in the optical recording medium, the address of a recording area is identified based on a land pre-pit signal obtained from the land pre-pits. A land pre-pit normally contains the address of the groove located on the inner circumference side thereof and is formed on the outer circumference side of a position (inflection point) where the groove wobbles to the most outer circumference side. Therefore, when data are to be recorded, the address of the groove which is being irradiated with the laser beam can be identified by extracting a land pre-pit signal obtained from the land pre-pit located on the outer circumference side with respect to the spot center of the laser beam.

The above mentioned wobble signal and land pre-pit signal are extracted from a push-pull signal (PP signal) generated based on the output of photodetectors for detecting the laser beam reflected from the groove.

FIG. 9 is a diagram showing a method for generating a push-pull signal based on the output of photodetectors.

As shown in FIG. 9, if a spot 12 of a laser beam is divided into two portions along the extending direction of the groove, the amount of the laser beam reflected by the optical recording medium 10 and entering an optical head is detected so that light components thereof on the outer circumference side of the center of the spot 12 are detected by a photodetector 13a and that light components thereof on the inner circumference side of the center of the spot 12 are detected by a photodetector 13b.

A detection signal A generated by the photodetector 13a and a detection signal B generated by the photodetector 13b are added by an adder to generate an addition signal (A+B) and the detection signal B is subtracted from the detection signal A by a subtracter to generate a subtraction signal (A−B). The addition signal (A+B) is used as a reproduction signal (HF signal) and the subtraction signal (A−B) is used as a push-pull signal.

FIG. 10 is a diagram showing the waveform of a push-pull signal obtained by projecting a laser beam onto a recording layer along a groove.

As described above, the push-pull signal represents the difference (A−B) between the detection signal A and the detection signal B obtained in the case of dividing the laser beam reflected from the optical recording medium into light components included in the laser beam on the outer circumference side of the center thereof and light components included in the laser beam on the inner circumference side of the center thereof. Since the frequency of the wobble is set to be much higher than the tracking servo band, the push-pull signal does not follow the wobble and, therefore, a wobble signal appears on the push-pull signal.

As shown in FIG. 10, the main component of the push-pull signal coincides with the cycle of the wobble and pulses 18 caused by the land pre-pits appear at predetermined times. Therefore, a wobble signal can be obtained by removing the pulses 18 using a low-pass filter or the like.

The pulses 18a directed toward the minus direction among the pulses 18 in FIG. 10 are pulses caused by the land pre-pits located on the outer circumference side of the center of the laser beam spot. As described above, since the land pre-pits are formed on the outer circumference side of a position (inflection point) where the groove wobbles to the most outer circumference side, as shown in FIG. 10, the pulses 18a directed toward the minus direction appear at positions where the wobble component included in the push-pull signal reaches the minus peak.

On the other hand, the pulses 18b directed toward the plus direction among the pulses 18 in FIG. 10 are pulses caused by the land pre-pits located on the inner circumference side of the center of the laser beam spot. As a result, the pulses 18b directed toward the plus direction appear substantially independently of the wobble component included in the push-pull signal.

Therefore, as shown in FIG. 10, if a predetermined threshold value of the push-pull signal is determined, it is possible to extract only the pulses 18a caused by the land pre-pits located on the outer circumference side of the center of the laser beam spot. The thus extracted pulses 18a are used as a land pre-pit signal. In order to prevent the pulses 18a directed toward the minus direction and the pulses 18b directed toward the plus direction from appearing simultaneously, the land pre-pits are formed so as not to align in the radial direction of the optical recording medium.

FIG. 11 is a schematic partial perspective view showing an optical recording medium formed with land pre-pits, wherein FIG. 11(a) shows an optical recording medium formed with land pre-pits at substantially central portions of a land, FIG. 11(b) shows an optical recording medium formed with land pre-pits offset to an inner circumference side, and FIG. 11(c) shows an optical recording medium formed with land pre-pits constituted by meandering portions of the groove.

The structure shown in FIG. 11(a) is shown, for example, in FIG. 3 of Japanese Patent Application Laid Open No. 2002-32918, the structure shown in FIG. 11(b) is shown, for example, in FIG. 1 of Japanese Patent Application Laid Open No. 2001-118288, and the structure shown in FIG. 11(c) is shown, for example, in FIG. 5 of Japanese Patent Application Laid Open No. 2002-25121. In FIGS. 10(a) to 10(c), the groove is drawn straight for simplicity.

In the case of fabricating a substrate 20a formed with land pre-pits at substantially central portions of a land as shown in FIG. 11(a) or a substrate 20b formed with land pre-pits offset to an inner circumference side, a stamper for fabricating the substrate 20a, 20b of an optical recording medium is fabricated using a photoresist-coated glass board whose land pre-pits 22a, 22b are cut using a laser beam independent of the laser beam for forming the groove 21a, 21b. In this specification, the method for fabricating a stamper for an optical recording medium by cutting a photoresist-coated glass board using one laser beam for forming a groove and another laser beam for forming land pre-pits in this manner is referred to as the “two-beam cutting method.”

To the contrary, in the case of fabricating a substrate 20c formed with land pre-pits constituted by meandering portions of the groove, a stamper for fabricating the substrate 20c of an optical recording medium is fabricated by a photoresist-coated glass board cut using a single laser beam. In this case, when the land pre-pit 22c is to be formed, a laser beam is projected so as to be greatly offset to the outer circumference side, whereby the land pre-pit 22c is formed by the meandering portion of the groove. In this specification, the method for fabricating a stamper for an optical recording medium by cutting a photoresist-coated glass board using a single laser beam in this manner is referred to as the “one-beam cutting method.”

In this manner, in the case of fabricating an optical recording medium formed with land pre-pits, a stamper used for fabricating the substrate of the optical recording medium can be fabricated using the two-beam cutting method or the one-beam cutting method.

However, in an optical recording medium fabricated using a stamper for the optical recording medium fabricated using the two-beam cutting method, once data are recorded therein, the land pre-pit signal is greatly degraded. The degree of the degradation of a land pre-pit signal is normally estimated using a parameter called the “aperture ratio (AR),” which is defined by the following formula where LPPa is the minimum value of a land pre-pit signal obtained after data were once recorded in the optical recording medium and LPPb is the maximum value thereof. This aperture ratio (AR) is lower in an optical recording medium fabricated using a stamper for an optical recording medium fabricated using the two-beam cutting method than that in an optical recording medium fabricated using a stamper for an optical recording medium fabricated using the one-beam cutting method.

AR (%)=100×LPPa/LPPb

The minimum value LPPa of the land pre-pit signal is generally obtained from a land pre-pit greatly influenced by heat generated by the formation of a long record mark in an adjacent groove. The maximum value LPPb of the land pre-pit signal is generally obtained from a land pre-pit little influenced by heat because a short record mark or a blank region is present in an adjacent groove. Therefore, in the case where the aperture ratio is small, the land pre-pit signal is apt to be influenced by the recording of data in an adjacent groove and a serious problem arises particularly in a data rewritable-type optical recording medium.

On the other hand, in an optical recording medium fabricated using a stamper for an optical recording medium fabricated using the one-beam cutting method, since a projecting portion is provided on the surface opposite to the land pre-pit, a high aperture ratio can be more easily obtained than in the case of an optical recording medium fabricated using a stamper for an optical recording medium fabricated using the two-beam cutting method. However, since the groove and the land pre-pits are formed using a single laser beam, if a large projecting portion is formed on the surface opposite to the land pre-pit, the fluctuation of a local groove parameter at the land pre-pit portion tends to become great. As a result, although a high aperture ratio can be easily obtained, it is difficult for requirements for various parameters such as jitter, PI errors (Paruty of inner-code errors), detracking tolerance and the like to be simultaneously satisfied in a desired manner.

### SUMMARY OF THE INVENTION

It is therefore an object of the present invention to provide a method for cutting a photoresist-coated glass board which can obtain a high aperture ratio and suppress fluctuation of a local groove parameter at a land pre-pit portion and a cutting machine for cutting a photoresist-coated glass board which can obtain a high aperture ratio and suppress fluctuation of a local groove parameter at a land pre-pit portion.

It is another object of the present invention to provide a method for manufacturing an optical recording medium which has a high aperture ratio and in which requirements for various parameters such as jitter, PI errors (Paruty of inner-code errors), detracking tolerance and the like can be simultaneously satisfied in a desired manner.

The above and other objects of the present invention can be accomplished by a method for cutting a photoresist-coated glass board used for fabricating a stamper for an optical recording medium, the method comprising steps of intermittently projecting a first laser beam onto the photoresist-coated glass board and intermittently projecting a second laser beam in synchronism with blocking the first laser beam onto the photoresist-coated glass board, thereby continuously and spirally forming an exposed region.

In a preferred aspect of the present invention, the method comprises a step of blocking the second laser beam so as to prevent portions of the exposed region from being aligned with each other in the radial direction of the photoresist-coated glass board if at least an adjacent portion of the exposed region in the radial direction has been formed by irradiation with the second laser beam.

In a further preferred aspect of the present invention, the method comprises a step of condensing the first laser beam and the second laser beam using a common objective lens.

In a further preferred aspect of the present invention, the first laser beam is adapted for forming a groove and the second laser beam is adapted for forming land pre-pits.

In a further preferred aspect of the present invention, the second laser beam is projected onto at least a part of portions corresponding to the land pre-pits.

In a further preferred aspect of the present invention, the first laser beam is blocked in at least a part of portions corresponding to the land pre-pits.

According to the present invention, when a photoresist-coated glass board is cut by the two-beam cutting method using a laser beam for forming a groove and a laser beam for forming land pre-pits, since these laser beams are intermittently projected onto the photoresist-coated glass board, the land pre-pits can be formed by meandering portions of the groove similarly to the case of cutting the photoresist-coated glass board using the one-beam cutting method. Therefore, it is possible to form the groove so as to have a similar shape to that formed using the one-beam cutting method and to increase the degree of freedom of the shape of the land pre-pit, particularly, the degree of freedom of the projecting portion of the land formed on the opposite surface to the land pre-pit.

Accordingly, a high aperture ratio can be obtained similarly to the case of using the one-beam cutting method and a sufficient land pre-pit signal can be obtained similarly to the case of using the two-beam cutting method. Therefore, according to the present invention, a high aperture ratio can be obtained and the requirements for various parameters such as jitter, PI errors (Paruty of inner-code errors), detracking tolerance and the like can be simultaneously satisfied in a desired manner.

Although the reason why a high aperture ratio can be obtained when the land pre-pits are constituted by meandering portions of the groove is not altogether clear, it is reasonable to conclude that when the land pre-pits are constituted by meandering portions of the groove, a projecting portion of a land is formed on the inner circumference side of the land pre-pit, thereby improving the aperture ratio.

In a preferred aspect of the present invention, the second laser beam is projected onto the photoresist-coated glass board within the period that the first laser beam is blocked.

According to this preferred aspect of the present invention, since at least one of the first laser beam and the second laser beam is always projected onto the photoresist-coated glass board, it is possible to reliably prevent the exposed region from becoming discontinuous.

The above and other objects of the present invention can be also accomplished by a cutting machine for cutting a photoresist-coated glass board used for fabricating a stamper for an optical recording medium comprising a first light modulating unit provided in an optical path of a laser beam for forming a groove and adapted for pulse-like modulating the laser beam for forming a groove and a second light modulating unit provided in an optical path of a laser beam for forming land pre-pits and adapted for pulse-like modulating the laser beam for forming land pre-pits.

According to the present invention, since the laser beam for forming a groove can be pulse-like modulated using the first light modulating unit and the laser beam for forming land pre-pits can be pulse-like modulated using the second light modulating unit, even in the case where the two-beam cutting method is used, the land pre-pits can be formed by a meandering portions of the groove, similarly to the case where the one-beam cutting method is used. Therefore, it is possible to form the groove so as to have a shape similar to that formed using the one-beam cutting method and to increase the degree of freedom of the shape of the land pre-pit.

The above and other objects of the present invention can be also accomplished by a method for manufacturing an optical recording medium comprising steps of projecting a laser beam onto a photoresist-coated glass board to expose it, thereby forming a raised and depressed pattern on a surface of the photoresist-coated glass board, forming a metal film on the surface of the photoresist-coated glass board formed with the raised and depressed pattern, transferring the raised and depressed pattern formed on the surface of the photoresist-coated glass board, thereby fabricating a stamper for an optical recording medium formed with the raised and depressed pattern on the surface thereof, transferring the raised and depressed pattern formed on the surface of the stamper onto a surface of a substrate, thereby forming a groove and land pre-pits on the surface of the substrate, the photoresist-coated glass board being exposed by intermittently projecting a laser beam for forming a groove onto the photoresist-coated glass board and intermittently projecting a laser beam for forming land pre-pits.

According to the present invention, it is possible to manufacture an optical recording medium which has a high aperture ratio and in which requirements for various parameters such as jitter, PI errors (Paruty of inner-code errors), detracking tolerance and the like can be simultaneously satisfied in a desired manner.

The above and other objects and features of the present invention will become apparent from the following description made with reference to the accompanying drawings.

### BRIEF DESCRIPTION OF THE DRAWINGS

FIG. 1 is a diagram showing an apparatus for manufacturing a stamper for fabricating an optical recording medium which is a preferred embodiment of the present invention.

FIG. 2 is a diagram showing in detail the optical path of a synthesized laser beam passing through an objective lens.

FIG. 3 shows waveforms of control signals fed to light modulating units, paths of the spot of a laser beam for forming a groove and the spot of a laser beam for forming land pre-pits and the shape of an exposed region formed on a photosensitive material layer, where FIG. 3(a) is a diagram showing the waveform of a control signal fed to a light modulating unit, FIG. 3(b) is a diagram showing the waveform of a control signal fed to a light modulating unit, FIG. 3(c) is a diagram showing paths of the spot of a laser beam for forming a groove and the spot of a laser beam for forming land pre-pits, and FIG. 3(d) is a diagram showing the shape of an exposed region formed on a photosensitive material layer.

FIGS. 4(a) to 4(f) show steps for manufacturing a stamper for an optical recording medium.

FIGS. 5(a) to 5(c) show steps for fabricating an optical recording medium.

FIGS. 6(a) to 6(c) show steps for fabricating an optical recording medium subsequent to the steps shown in FIG. 5.

FIG. 7 is a schematic perspective view showing an optical recording medium fabricated by a method for manufacturing an optical recording medium which is a preferred embodiment of the present invention.

FIG. 8 is a schematic enlarged cross-sectional view of a portion indicated by A in FIG. 7.

FIG. 9 is a diagram showing a method for generating a push-pull signal based on the output of a photodetector.

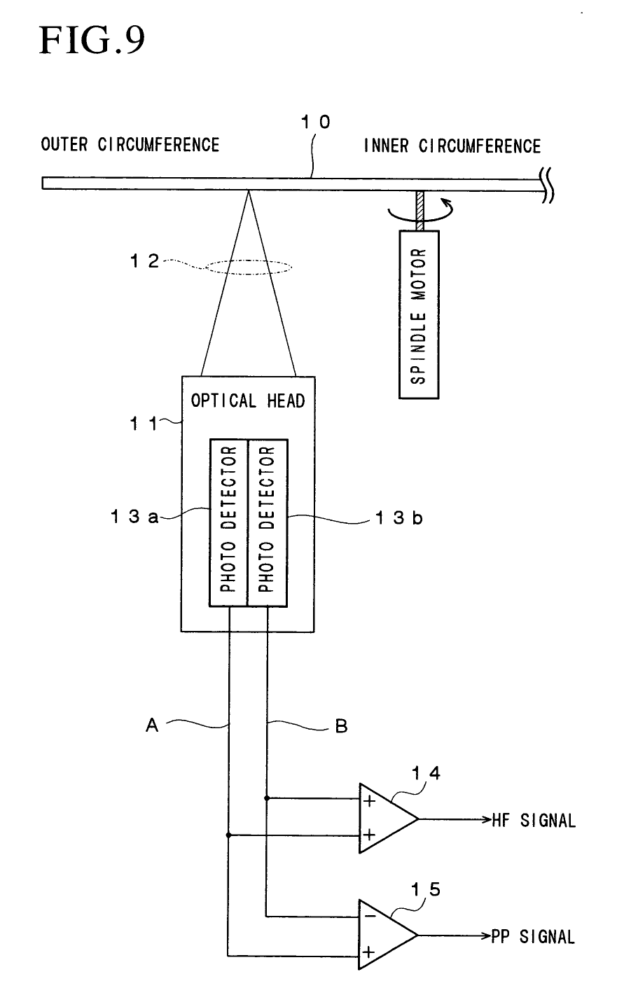

FIG. 10 is a diagram showing the waveform of a push-pull signal obtained by projecting a laser beam onto a recording layer along a groove.

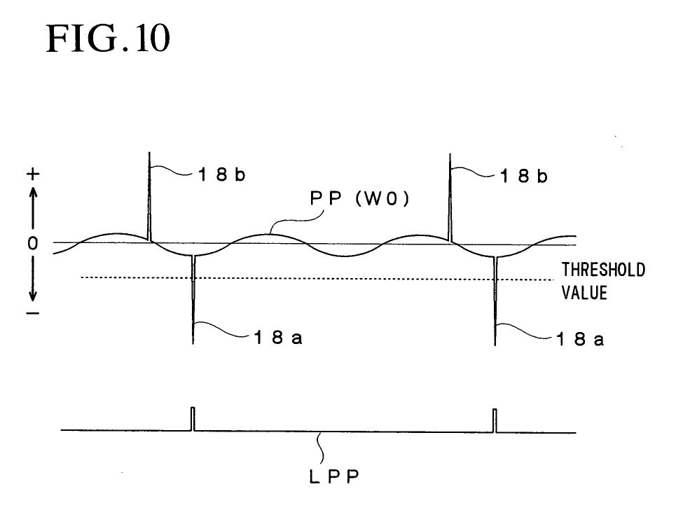

FIG. 11 is a schematic partial perspective view showing an optical recording medium formed with land pre-pits, wherein FIG. 11(a) shows an optical recording medium formed with land pre-pits at substantially central portions of a land, FIG. 11(b) shows an optical recording medium formed with land pre-pits offset to an inner side, and FIG. 11(c) shows an optical recording medium formed with land pre-pits constituted by meandering portions of a groove.

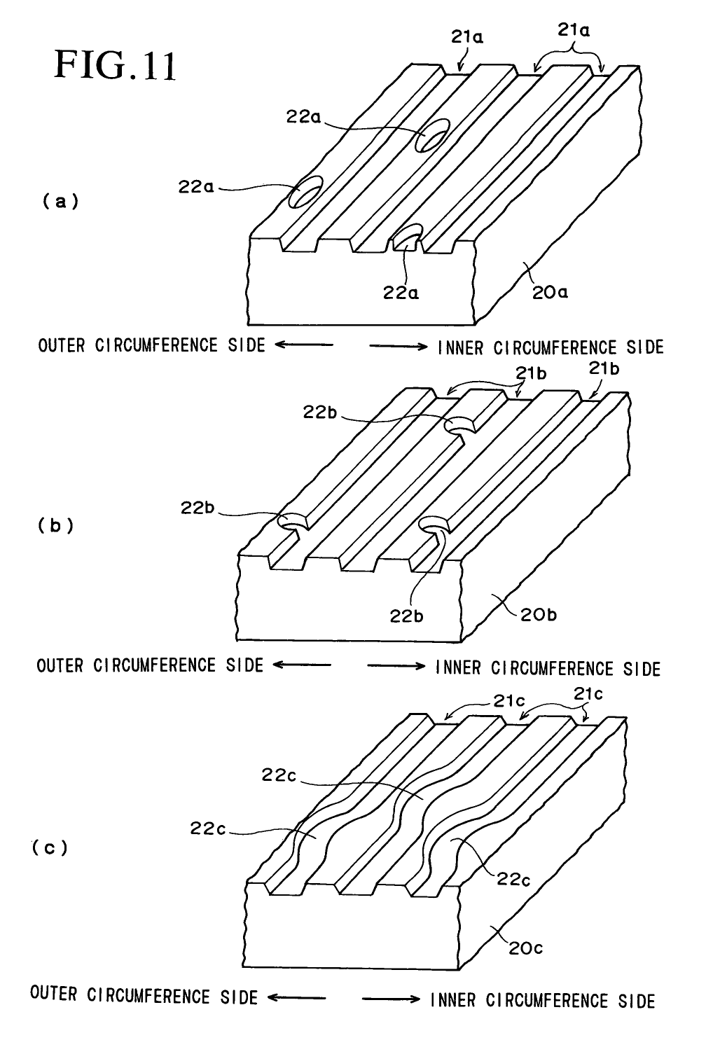

### DESCRIPTION OF THE PREFERRED EMBODIMENTS

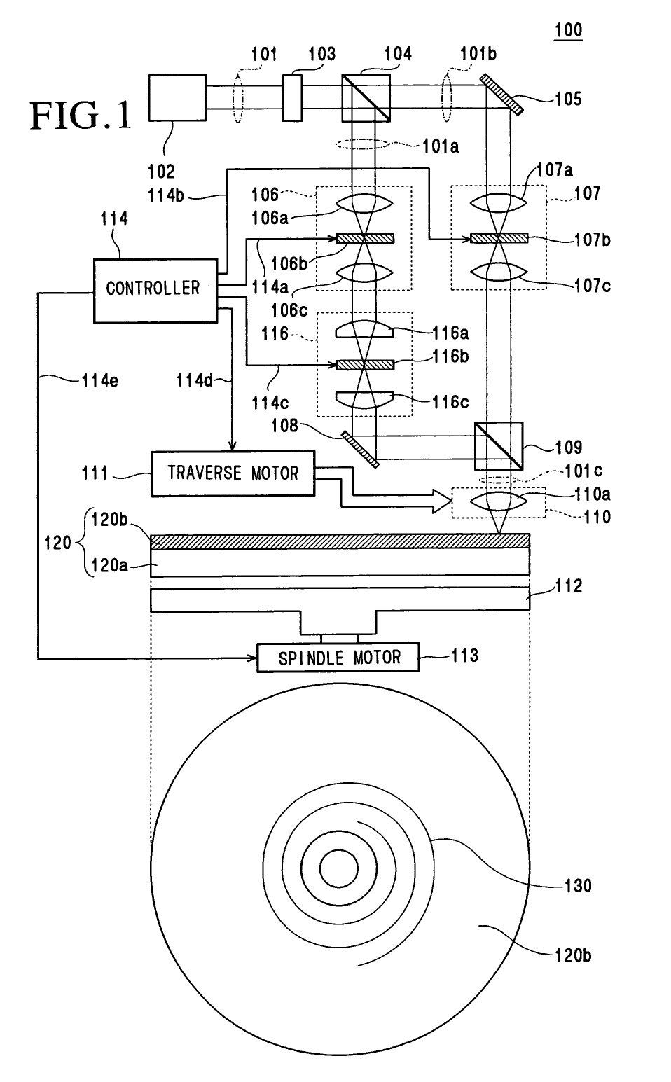

FIG. 1 is a diagram showing an apparatus (cutting machine) for manufacturing a stamper for fabricating an optical recording medium which is a preferred embodiment of the present invention.

As shown in FIG. 1, a cutting machine 100 according to this embodiment is constituted as an apparatus for cutting a photoresist-coated glass board and includes a laser beam generating device 102 for generating a laser beam 101, an electrooptic modulator (EOM) 103 for modulating the power of the laser beam 101 using an electrooptic effect to a power suitable for exposing a photoresist-coated glass board, a half mirror 104 for dividing the laser beam 101 into a laser beam 101a for forming a groove and a laser beam 101b for forming land pre-pits, a mirror 105 for reflecting the laser beam 101b for forming land pre-pits, a light modulating unit 106 for pulse-like modulating the laser beam 101a for forming a groove, a deflecting unit 116 for wobbling the laser beam 101a for forming a groove, a light modulating unit 107 for pulse-like modulating the laser beam 101b for forming land pre-pits, a mirror 108 for reflecting the laser beam 101a for forming a groove, a half mirror 109 for synthesizing the laser beam 101a for forming a groove and the laser beam 101b for forming land pre-pits to generate a synthesized laser beam 101c, an optical head 110 for projecting the synthesized laser beam 101c onto a photoresist-coated glass board 120, a traverse motor 111 for moving the optical head 110 in a radial direction of the photoresist-coated glass board 120, a turn-table 112 on which the photoresist-coated glass board 120 is placed, a spindle motor 113 for rotating the turn-table 112, and a controller 114 for controlling the light modulating units 106, 107, the traverse motor 111 and the spindle motor 113.

The photoresist-coated glass board 120 is constituted of a glass substrate 120a and a photosensitive material layer 120b formed on the glass substrate 120a to a thickness of 100 to 150 nm.

The light modulating unit 106 includes a lens 106a, a light modulator 106b and a lens 106c and is adapted for pulse-like modulating the laser beam 101a for forming a groove based on a control signal 114a fed from the controller 114 thereto. Similarly, the light modulating unit 107 includes a lens 107a, a light modulator 107b and a lens 107c and is adapted for pulse-like modulating the laser beam 101b for forming land pre-pits based on a control signal 114b fed from the controller 114 thereto.

In this embodiment, the light modulator 106 is constituted so as to transmit the laser beam 101a for forming a groove therethrough when the level of the control signal 114a is high and to block the laser beam 101a for forming a groove when the level of the control signal 114a is low. Similarly, in this embodiment, the light modulator 107 is constituted so as to transmit the laser beam 101b for forming land pre-pits therethrough when the level of the control signal 114b is high and to block the laser beam 101b for forming land pre-pits when the level of the control signal 114b is low.

The deflecting unit 116 includes a cylindrical lens 116a, a deflector 116b and a cylindrical lens 116c and is adapted for wobbling the laser beam 101a for forming a groove based on a control signal 114c fed from the controller 114 thereto.

The optical head 110 includes at least an objective lens 110a and is adapted for condensing the synthesized laser beam 101c arriving from the half mirror 109 onto the photosensitive material layer 120b of the photoresist-coated glass board 120. The optical head 110 is constituted so as to be moved in the radial direction of the photoresist-coated glass board 120 by the traverse motor 111 controlled by a control signal 114d fed from the controller 114.

The spindle motor 113 is adapted for rotating the turn-table 112 based on a control signal 114e fed from the controller 114.

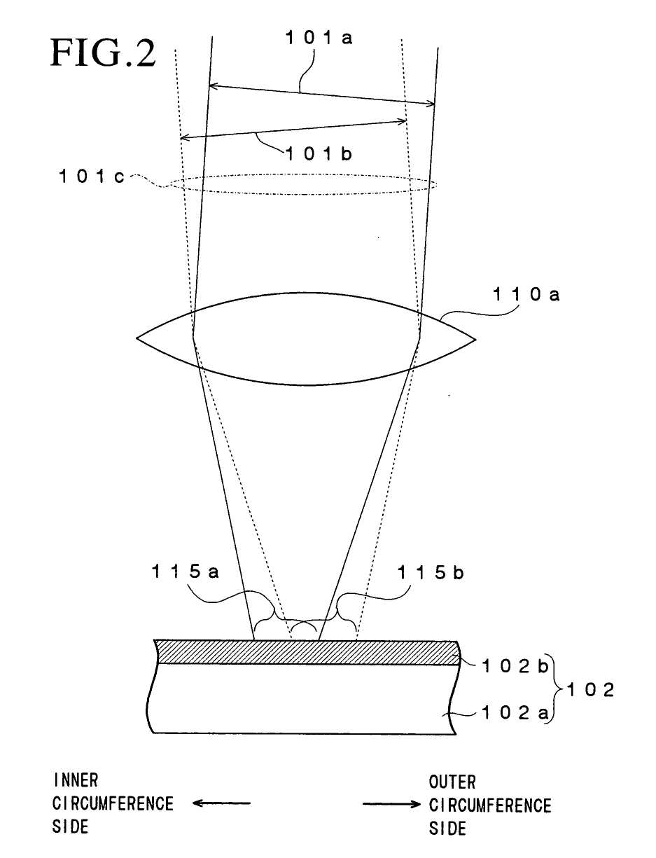

FIG. 2 is a diagram showing in detail the optical path of the synthesized laser beam 101c passing through the objective lens 110a.

As shown in FIG. 2, before the synthesized laser beam 101c passes through the objective lens 110a, it is synthesized so that the optical axis of the laser beam 101a for forming a groove and that of the laser beam 101b for forming land pre-pits do not coincide with each other but are at an angle with each other. Therefore, when the synthesized laser beam 101c passing through the objective lens 110a impinges on the photosensitive material layer 120b, the spot 115a of the laser beam 101a for forming a groove and the spot 115b of the laser beam 101b for forming land pre-pits are offset from each other to a predetermined extent. More specifically, the position where the spot 115a of the laser beam 101a for forming a groove is formed and the position where the spot 115b of the laser beam 101b for forming land pre-pits is formed are offset from each other in the radial direction of the photoresist-coated glass board 120 so that the spot 115a of the laser beam 101a for forming a groove is located on the inner circumference side and the spot 115b of the laser beam 101b for forming land pre-pits is located on the outer circumference side.

The thus constituted cutting machine 100 operates as follows.

In the case where the photoresist-coated glass board 120 is to be cut using the cutting machine 100, the controller 114 first outputs a control signal 114d to control the traverse motor 111, thereby causing it to move the optical head 110 to the inner circumference portion of the photoresist-coated glass board 120 and outputs a control signal 114e to control the spindle motor 113, thereby causing it to rotate the turn-table 112.

In this state, the laser beam 101 is generated by the laser beam generating device 102. The laser beam 101 generated by the laser beam generating device 102 enters the electrooptic modulator 103 and the power thereof is modulated to a level suitable for exposing the photoresist-coated glass board 120. The laser beam 101 is divided by the half mirror 104 into a laser beam 101a for forming a groove and a laser beam 101b for forming land pre-pits.

The laser beam 101a for forming a groove passes through the light modulating unit 106 and the deflecting unit 116 and is reflected by the mirror 108 to advance to the half mirror 109.

On the other hand, the laser beam 101b for forming land pre-pits is reflected by the mirror 105 and passes through light modulating unit 107 to advance the half mirror 109.

The laser beam 101a for forming a groove and the laser beam 101b for forming land pre-pits are synthesized by the half mirror 109 to generate a synthesized laser beam 101c and the synthesized laser beam 101c is condensed onto the photosensitive material layer 120b of the photoresist-coated glass board 120 by the objective lens 110a of the optical head 110.

Further, the controller 114 outputs a control signal 114a and a control signal 114b to the light modulating units 106 and 107 to control them, thereby causing them to pulse-like modulate the laser beam 101a for forming a groove and the laser beam 101b for forming land pre-pits, and outputs a control signal 114c to the deflecting unit 116 to control it, thereby causing it to wobble the laser beam 101a for forming a groove.

At the same time, the controller 114 outputs a control signal to the traverse motor 11 to control it, thereby causing it to gradually move the optical head 110 toward the outer circumference portion of the photoresist-coated glass board 120.

As a result, the spot 115a of the laser beam 101a for forming a groove and the spot 115b of the laser beam 101b for forming land pre-pits formed on the photosensitive material layer 120b move along a spiral path from the inner circumference portion of the photosensitive material layer 120b toward the outer circumference portion thereof. On the other hand, since the controller 114 outputs a control signal corresponding to the wobble to the deflecting unit 116, the spot 115a of the laser beam 101a for forming a groove moves along the spiral path while wobbling in the radial direction of the photoresist-coated glass board 120.

A region of the photosensitive material layer 120b where the spot 115a of the laser beam 101a for forming a groove and the spot 115b of the laser beam 101b for forming land pre-pits are formed is exposed to the laser beam 101a for forming a groove and the laser beam 101b for forming land pre-pits and, as shown in FIG. 1, a spiral exposed region 130 is formed on the photosensitive material layer 120b so as to wobble in the radial direction of the photoresist-coated glass board 120.

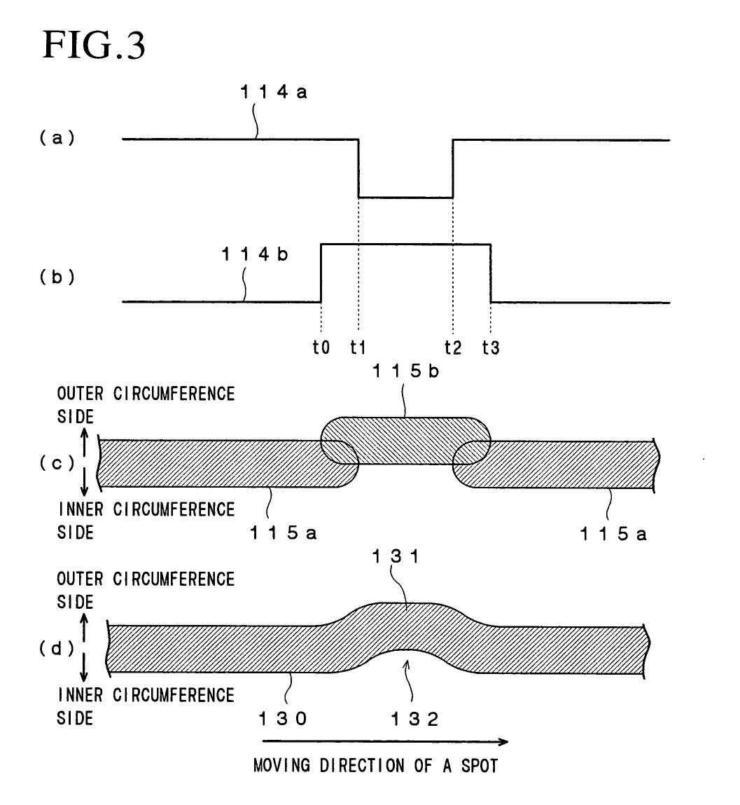

FIG. 3 shows waveforms of the control signals 114a and 114b fed to the light modulating units 106 and 107, paths of the spot 115a of the laser beam 101a for forming a groove and the spot 115b of the laser beam 101b for forming land pre-pits and the shape of the exposed region 130 formed on the photosensitive material layer 120b, where FIG. 3(a) is a diagram showing the waveform of the control signal 114a fed to the light modulating unit 106, FIG. 3(b) is a diagram showing the waveform of the control signal 114b fed to the light modulating unit 107, FIG. 3(c) is a diagram showing the paths of the spot 115a of the laser beam 101a for forming a groove and the spot 115b of the laser beam 101b for forming land pre-pits, and FIG. 3(d) is a diagram showing the shape of the exposed region 130 formed on the photosensitive material layer 120b.

As shown in FIG. 3(a), the control signal 114a fed to the light modulating unit 106 is set to low level at a predetermined time when the spot 115a of the laser beam 101a for forming a groove reaches a portion where a land pre-pit is to be formed and set to high level at other times.

On the other hand, as shown in FIG. 3(b), the control signal 114b fed to the light modulating unit 107 is set to high level at a predetermined time when the spot 115b of the laser beam 101b for forming land pre-pits reaches a portion where a land pre-pit is to be formed and set to low level at other times.

In this embodiment, the time t0 when the control signal 114b becomes high level is defined to be earlier than the time t1 when the control signal 114a becomes low level and the time t2 when the control signal 114b becomes low level is defined to be later than the time t3 when the control signal 114a becomes high level. The land pre-pit is formed on the outer circumference side of a position (inflection point) where the groove wobbles to the most outer circumference side.

As a result, the spot 115a of the laser beam 101a for forming a groove located at a position where a land pre-pit is to be formed and the spot 115b of the laser beam 101b for forming land pre-pits located at a position where a land pre-pit is to be formed traverse the paths shown in FIG. 3(c) and, as shown in FIG. 3(d), the photosensitive material layer 120b is exposed in a manner similar to when using the one-beam cutting method.

Of the exposed region on the photosensitive material layer 120b, the shape of a portion 131 corresponding to the land pre-pit can be mainly adjusted by on-pulses of the control signal 114b and the shape of a portion 132 corresponding to the projecting portion (unexposed region) located on the inner circumference side of the land pre-pit can be mainly adjusted by off-pulses of the control signal 114a. Therefore, the shape of the portion 131 corresponding to the land pre-pit and the shape of the portion 132 corresponding to the projecting portion can be adjusted independently of each other.

In this manner, the exposed region 130 wobbles at a predetermined interval and has the portion 131 corresponding to the land pre-pit. In the case where an adjacent exposed region 130 on the inner circumference side is a portion 131 corresponds to a land pre-pit, the control signal 114 is controlled so as not to be set to high level, thereby preventing land pre-pits from being formed on the opposite sides of a groove.

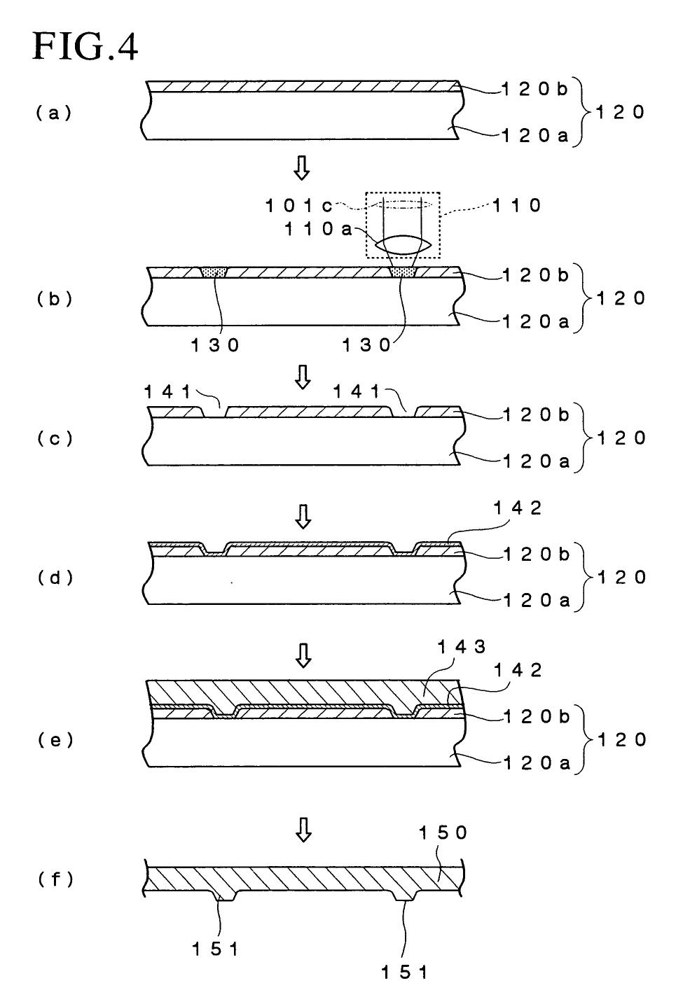

FIGS. 4(a) to 4(f) shows steps for manufacturing a stamper for an optical recording medium.

As shown in FIG. 4(a), a photoresist-coated glass board 120 including a glass substrate 120a and a photosensitive material layer 120b formed on the glass substrate 120a to have a thickness of 20 to 200 nm is first prepared. An adhesive layer may be formed between the glass substrate 120a and the photosensitive material layer 120b for improving the adhesiveness therebetween.

Then, as shown in FIG. 4(b), a synthesized laser beam 101c whose power is being modulated by the light modulators 106b, 107b is condensed by the objective lens 110a onto the photosensitive material layer 120b of the photoresist-coated glass board 120, whereby the region of the photosensitive material layer 120b onto which the synthesized laser beam 101c is condensed is exposed.

As a result, an exposed region 130 corresponding to a groove is spirally formed. The exposed region 130 corresponding to the groove wobbles at a predetermined interval and a meandering portion thereof constitutes the portion 131 corresponding to the land pre-pit.

Then, a developing solution such as sodium hydroxide is sprayed onto the thus exposed photoresist-coated glass board 120, thereby developing the photosensitive material layer 120b and as shown in FIG. 4(c), concave portions are formed correspondingly to the exposed region 130.

Next, as shown in FIG. 4(d), a thin metal film 142 of nickel, for example, is formed on the developed photosensitive material layer 120b by electroless plating or deposition.

Further, as shown in FIG. 4(e), a thick metal film 143 having a thickness of about 0.3 mm is formed on the surface of the thin metal film 142 by thick film plating using the surface of the metal thin film 142 as a negative electrode and nickel or the like as a positive electrode.

The photoresist-coated glass board 120 is then peeled off from the thin metal film 142, followed cleaning and inner and outer diameter processing, thereby affording a stamper 150 for forming an optical recording medium, as shown in FIG. 4(f).

The thus fabricated stamper 150 for forming an optical recording medium is formed with a convex pattern formed by transferring the pattern of the concave portions 141 of the photoresist-coated glass board 120.

A write-once optical recording medium is fabricated using the stamper 150 for an optical recording medium.

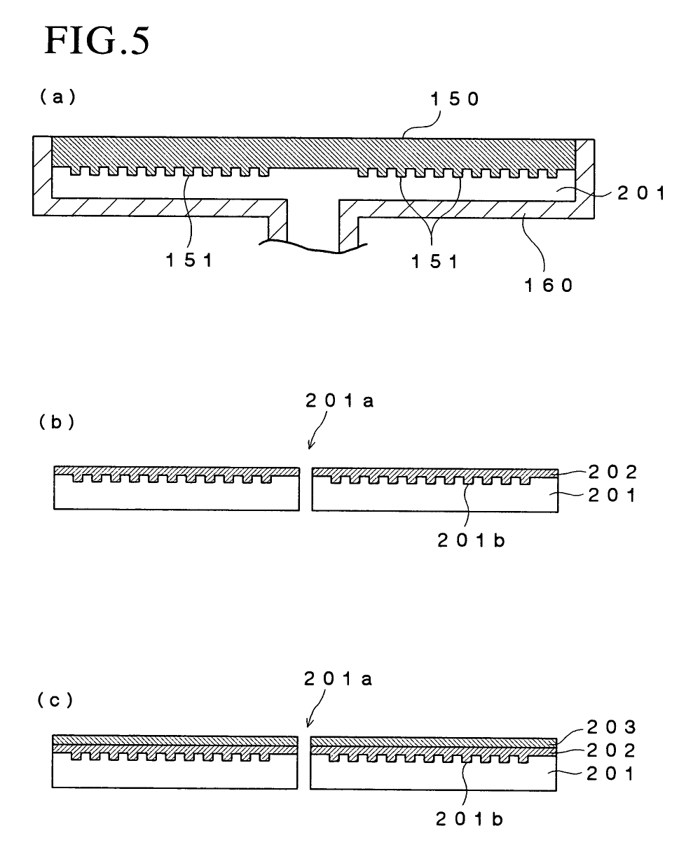

FIGS. 5(a) to 5(c) show steps for fabricating an optical recording medium.

The stamper 150 fabricated in the above described manner is set in an injection molding apparatus and a disk-like light transmittable substrate 201 having a diameter of about 120 mm and a thickness of about 0.6 mm and formed with a center hole is injection molded.

In this manner, as shown in FIG. 5(a), a light transmittable substrate 201 on which the spiral convex pattern 151 formed on the surface of the stamper 150 is transferred is fabricated.

A groove is formed by a concave portion formed by transferring the spiral convex pattern 151 formed on the surface of the stamper 150 and land pre-pits are formed by the meandering portions of the groove.

The material used to form the light transmittable substrate 201 is not particularly limited insofar as it has a high light transmittance with respect to the wavelength of the laser beam used for recording and reproducing data but polycarbonate resin and polyolefin resin are preferably used for forming the light transmittable substrate 201.

Then, as shown in FIG. 5(b), a recording layer 202 is formed on the surface of the light transmittable substrate 201 on the side of the groove so as to have a thickness of 30 to 300 nm on the groove.

The recording layer 202 is a layer in which a record mark is formed by a laser beam projected thereonto when data are to be recorded.

The recording layer 202 contains an organic dye such as a cyanine dye, merocyanine dye, methine dye or derivatives thereof, a benzenethiol metal complex, a phthalocyanine dye, a naphthalocyanine dye, an azo dye or the like.

The recording layer 202 is preferably formed using a spin coating process.

In FIG. 5(b), the reference numeral 201a designates a hole formed at the center portion of the light transmittable substrate 201 and the reference numeral 201b designates a groove formed by transferring the convex pattern 151 formed on the surface of the stamper 150 onto the light transmittable substrate 201.

Then, as shown in FIG. 5(c), a reflective layer 203 having a thickness of 50 to 200 nm is formed on the recording layer 202.

The reflective layer 203 is adapted for reflecting a laser beam projected thereonto when data are to be reproduced.

The material used to form the reflective layer 203 is not particularly limited insofar as it can reflect a laser beam, and the reflective layer 203 can be formed of Mg, Al, Ti, Cr, Fe, Co, Ni, Cu, Zn, Ge, Ag, Pt, Au or the like. Among these materials, it is preferable to form the reflective layer 203 of a metal material having a high reflection characteristic, such as Al, Au, Ag, Cu or alloy containing at least one of these metals, such as alloy of Al and Ti.

The reflective layer 203 can be formed by a vapor phase growth process using chemical species containing elements for forming the reflective layer 203. Illustrative examples of the vapor phase growth processes include vacuum deposition, sputtering and the like.

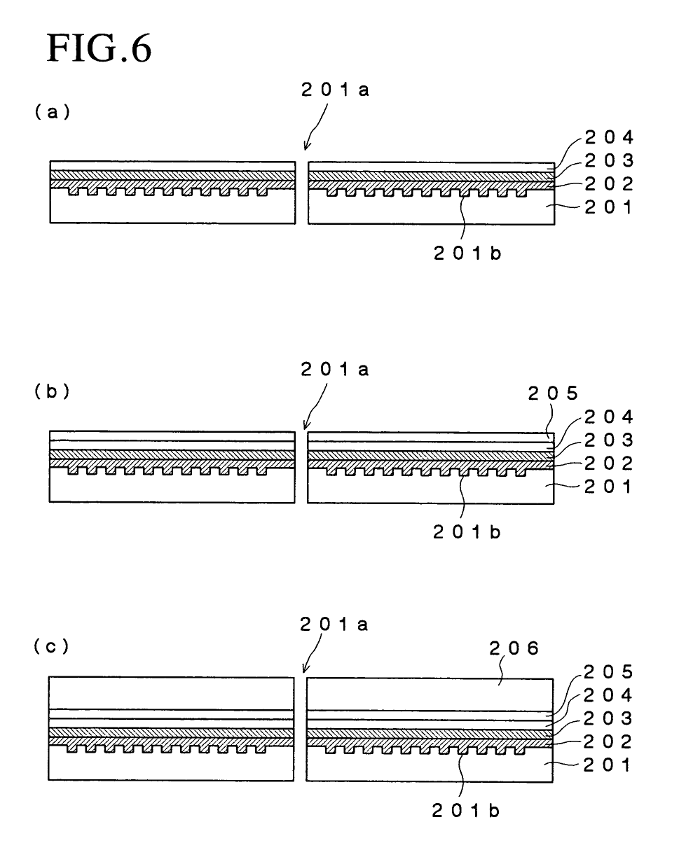

FIGS. 6(a) to 6(c) show steps for fabricating an optical recording medium subsequent to the steps shown in FIG. 5.

As shown in FIG. 6(a), a protective layer 204 having a thickness of 0.5 to 100 μm is formed on the reflective layer 203.

The protective layer 204 serves to physically and chemically protect the recording layer 202 and the reflective layer 203 formed on the light transmittable substrate 201. The material used to form the protective layer 204 is not particularly limited and the protective layer 204 can be formed by curing acrylic ultraviolet curable resin or epoxy ultraviolet curable resin, for example.

The protective layer 204 can be formed by dissolving acrylic ultraviolet curable resin or epoxy ultraviolet curable resin in a solvent to prepare a resin solution, applying the resin solution on the reflective layer 203 by a spin coating process to form a coating layer and projecting an ultraviolet ray onto the coating layer, thereby curing the ultraviolet curable resin. The protective layer 204 may be formed using a roll coating process, a screen printing process or the like.

Then, as shown in FIG. 6(b), an adhesive layer 205 having a thickness of 10 to 200 μm is formed on the protective layer 204.

The adhesive layer 205 serves to adhering a laminate including the light transmittable substrate 201, the recording layer 202, the reflective layer 203 and the protective layer 204 and a dummy substrate described later and is preferably formed of ultraviolet ray curable adhesive agent.

The adhesive layer 205 can be formed using a spin coating process, a roll coating process, a screen printing process or the like.

On the other hand, a dummy substrate 206 having a thickness of about 0.6 mm and a diameter of about 120 mm is separately fabricated by an injection molding process.

Then, as shown in FIG. 6(c), the dummy substrate 206 is contacted with the adhesive layer 205 of the laminate and the adhesive layer 205 is cured by the irradiation with an ultraviolet ray, thereby adhering the dummy substrate 206 and the laminate including the light transmittable substrate 201, the recording layer 202, the reflective layer 203, the protective layer 204 and the adhesive layer.

The dummy substrate 206 is a disk-like substrate for ensuring the thickness required for fabricating the optical recording medium and has a thickness of about 0.6 mm similarly to the light transmittable substrate 201.

The laser beam is not transmitted through the dummy substrate 206 when data are recorded in the optical recording medium and data are reproduced from the optical recording medium, so, unlike the light transmittable substrate 201, the dummy substrate 206 does not require high light transmittance. Therefore, the material for forming the dummy substrate 206 is not particularly limited but it is preferable to form the dummy substrate 206 of polycarbonate resin or polyolefin resin from the viewpoint of easy processing and the like

The optical recording medium is fabricated in the foregoing manner.

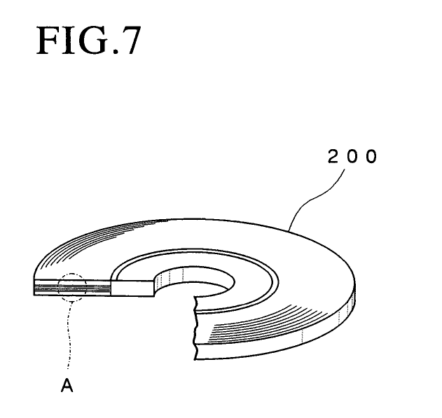

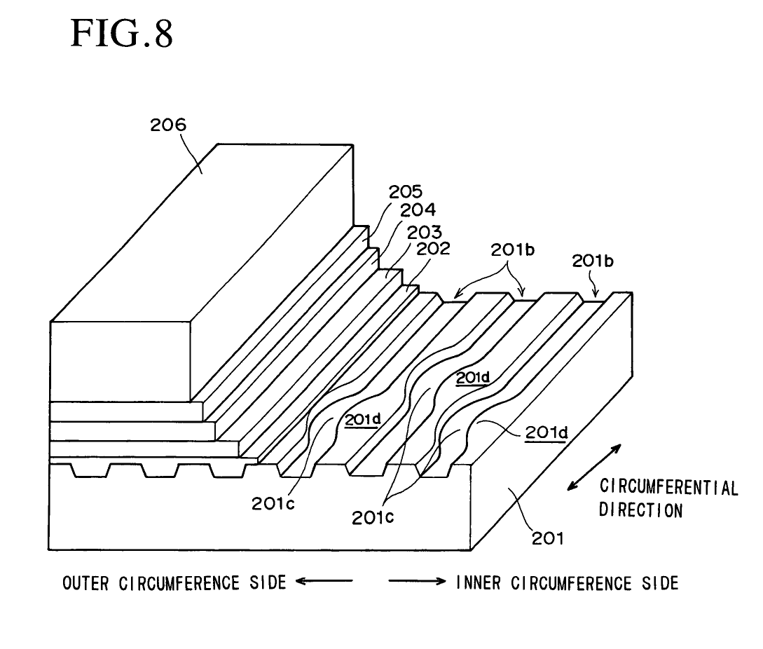

FIG. 7 is a schematic perspective view showing the thus fabricated optical recording medium and FIG. 8 is a schematic enlarged cross-sectional view of a portion indicated by A in FIG. 7.

As shown in FIG. 7, the optical recording medium 200 is constituted as a write-once type optical recording medium and the light transmittable substrate 201 of the optical recording medium 200 is formed with a groove 201b spirally formed by transferring the convex pattern 151 formed on the surface of the stamper 150 onto the light transmittable substrate 201 and the land pre-pits 201c are formed by the meandering portions of the groove 201b. In FIG. 8, the groove 201b is drawn straight for simplicity.

Data are recorded in the thus constituted optical recording medium 200 and data are reproduced from the optical recording medium 200 by projecting a laser beam onto the optical recording medium 200 from the side of the light transmittable substrate 201.

More specifically, when data are to be recorded in the optical recording medium 200, a laser beam whose power is being pulse-like modulated between the recording power Pw and the base power Pb is projected onto the recording layer 202 along the groove 201b. As a result, an organic dye contained in a region of the recording layer 202 irradiated with the laser beam chemically, or chemically and physically, changes to form a record mark, whereby data are recorded.

On the other hand, when data recorded in the optical recording medium 200 are to be reproduced, a laser beam whose power is set to the reproducing power Pr is projected onto the recording layer 202 along the groove 201b and the amount of the laser beam reflected from the optical recording medium 200 is detected, whereby data are reproduced.

When data are recorded in the optical recording medium 200 and when data are reproduced from the optical recording medium 200, the rotation of the spindle motor of a drive is controlled so that the frequency of a wobble signal obtained by the wobbling of the groove 201b and the frequency of the reference clock coincide with each other. As a result, it is possible to maintain a constant linear velocity irrespective of the recording position or the reproducing position in the radial direction of the optical recording medium 200.

Further, when data are to be recorded in the optical recording medium 200, the address of a recording area can be identified based on a land pre-pit signal obtained from the land pre-pits 201c constituted by the meandering portions of the groove 201b. Specifically, as described above, each land pre-pit 201c contains the address of the groove 201b located on the inner circumference side thereof. Therefore, if a land pre-pit signal produced by the land pre-pit located on the outer circumference side with respect to the center of the spot of the laser beam is extracted when data are to be recorded, it is possible to identify the address of the groove 201b onto which the laser beam is being projected.

In this case, in the write-once type optical recording medium 200 fabricated by the method according to this embodiment, since the land pre-pits 201c are constituted by the meandering portions of the groove 201b similarly to those formed by the one-beam cutting method, a high aperture ratio can be obtained in comparison with the case of using the two-beam cutting method. In addition, in this embodiment, since the shape of the land pre-pit 201c and the shape of the projecting portion 201d of a land located on the inner circumference side of the land pre-pit 201c can be adjusted independently of each other, the degree of freedom of the shape of the land pre-pit is high and, therefore, the requirements for various parameters such as jitter, PI errors (Paruty of inner-code errors), detracking tolerance and like can be simultaneously satisfied in a desired manner.

As described above, according to this embodiment, when the photoresist-coated glass board 120 is cut using the two-beam cutting method utilizing the laser beam 101a for forming a groove and the laser beam 101b for forming land pre-pits, since the laser beam 101a for forming a groove is once blocked at the portion 131 corresponding to the land pre-pit 201c, the land pre-pit 201c can be constituted by the meandering portion of the groove 201b similarly to that formed using the one-beam cutting method. Therefore, a groove having a shape similar to that formed using the one-beam cutting method can be formed and the degree of freedom of the shape of the land pre-pit can be increased in comparison with the case of using the one-beam cutting method. Accordingly, a high aperture ratio can be obtained similarly to the case of using the one-beam cutting method and a sufficient land pre-pit signal can be obtained similarly to the case of using the two-beam cutting method.

The present invention has thus been shown and described with reference to a specific embodiment. However, it should be noted that the present invention is in no way limited to the details of the described arrangements but changes and modifications may be made without departing from the scope of the appended claims.

For example, in the above described embodiment, the time t0 when the control signal 114b becomes high level is defined to be earlier than the time t1 when the control signal 114a becomes low level and the time t2 when the control signal 114b becomes low level is defined to be later than the time t3 when the control signal 114a becomes high level. However, it is not absolutely necessary to define the time t0 when the control signal 114b becomes high level to be earlier than the time t1 when the control signal 114a becomes low level and define the time t2 when the control signal 114b becomes low level to be later than the time t3 when control signal 114a becomes high level and, insofar as the laser beam 101a for forming a groove is once blocked at the portion 131 corresponding to the land pre-pit 201c, the waveforms of the control signals 114a, 114b, namely, the on and off timings of the laser beam 101a for forming a groove and the laser beam 101b for forming land pre-pits may be arbitrarily determined. However, if the time t0 when the control signal 114b becomes high level is defined to be later than the time t1 when the control signal 114a becomes low level or if the time t2 when the control signal 114b becomes low level is defined to be earlier than the time t3 when control signal 114a becomes high level, the exposed region 130 may become discontinuous under some exposure conditions, in which case the groove 201b is liable to become discontinuous. Therefore, it is preferable to determine the waveforms of the control signals 114a, 114b as in the above described embodiment.

Furthermore, in the above described embodiment, although the light transmittable substrate 201 is fabricated by an injection molding process using the stamper 150, the light transmittable substrate 201 may be fabricated by a photopolymer (2P) process.

Further, the above described embodiment was explained regarding the case of manufacturing the write-once type optical recording medium 200. However, the present invention is not limited to the manufacture of a write-once type optical recording medium but can be widely applied to manufacture of other optical recording media including land pre-pits such as a data rewritable type optical recording medium.

According to the present invention, it is possible to provide a method for cutting a photoresist-coated glass board which can obtain a high aperture ratio and suppress fluctuation of a local groove parameter at a land pre-pit portion and a cutting machine for cutting a photoresist-coated glass board which can obtain a high aperture ratio and suppress fluctuation of a local groove parameter at a land pre-pit portion.

Further, according to the present invention, it is possible to provide a method for manufacturing an optical recording medium which has a high aperture ratio and in which requirements for various parameters such as jitter, PI errors (Paruty of inner-code errors), detracking tolerance and the like can be simultaneously satisfied in a desired manner.

1. A method for cutting a photoresist-coated glass board used for fabricating a stamper for an optical recording medium, the method comprising steps of intermittently projecting a first laser beam onto the photoresist-coated glass board and intermittently projecting a second laser beam in synchronism with blocking the first laser beam onto the photoresist-coated glass board, thereby continuously and spirally forming an exposed region.

2. A method for cutting a photoresist-coated glass board in accordance with claim 1 which comprises a step of blocking the second laser beam so as to prevent portions of the exposed region from being aligned with each other in the radial direction of the photoresist-coated glass board if at least an adjacent portion of the exposed region in the radial direction has been formed by irradiation with the second laser beam.

3. A method for cutting a photoresist-coated glass board in accordance with claim 1 which comprises a step of condensing the first laser beam and the second laser beam using a common objective lens.

4. A method for cutting a photoresist-coated glass board in accordance with claim 1, wherein the first laser beam is adapted for forming a groove and the second laser beam is adapted for forming land pre-pits.

5. A method for cutting a photoresist-coated glass board in accordance with claim 4, wherein the second laser beam is projected onto at least a part of portions corresponding to the land pre-pits.

6. A method for cutting a photoresist-coated glass board in accordance with claim 4, wherein the first laser beam is blocked in at least a part of portions corresponding to the land pre-pits.

7. A method for cutting a photoresist-coated glass board in accordance with claim 4, wherein the second laser beam is projected onto the photoresist-coated glass board within the period that the first laser beam is blocked.

8. A cutting machine for cutting a photoresist-coated glass board used for fabricating a stamper for an optical recording medium comprising a first light modulating unit provided in an optical path of a laser beam for forming a groove and adapted for pulse-like modulating the laser beam for forming a groove and a second light modulating unit provided in an optical path of a laser beam for forming land pre-pits and adapted for pulse-like modulating the laser beam for forming land pre-pits.

9. A method for manufacturing an optical recording medium comprising steps of projecting a laser beam onto a photoresist-coated glass board to expose it, thereby forming a raised and depressed pattern on a surface of the photoresist-coated glass board, forming a metal film on the surface of the photoresist-coated glass board formed with the raised and depressed pattern, transferring the raised and depressed pattern formed on the surface of the photoresist-coated glass board, thereby fabricating a stamper for an optical recording medium formed with the raised and depressed pattern on the surface thereof, transferring the raised and depressed pattern formed on the surface of the stamper onto a surface of a substrate, thereby forming a groove and land pre-pits on the surface of the substrate, the photoresist-coated glass board being exposed by intermittently projecting a laser beam for forming a groove onto the photoresist-coated glass board and intermittently projecting a laser beam for forming land pre-pits.
